(19) United States
(12) Patent Application Publication
(10) Pub. No.: US 2010/0174601 A1
(43) Pub. Date: Jul. 8, 2010

(54) System and Method for Redeeming Coupons

(76) Inventor: Methinee Yu, Northville, MI (US)

Correspondence Address: WHITE-WELKER & WELKER, LLC, P.O. BOX 199, CLEAR SPRING, MD, 21722-0199, US

(21) Appl. No.: 12/349,497

(22) Filed: Jan. 6, 2009

(51) Int. Cl. G06Q 30/00; G06Q 10/00; G06Q 40/00

(52) U.S. Cl. 705/14.38; 705/30; 705/34; 705/26

(57) ABSTRACT

A method dealing with the marketing of manufacturer products using promotional coupons and web based point of sale technology that inventories and matches coupon promotions based on the demands of the consumer. Shopping lists are matched to coupons offered, which provides a mechanism for consumers to prioritize and anticipate buying based on expiration and/or value of coupons. Coupons are presented to the consumer via a website. As the consumer views each coupon, they can bank selected coupons. A coupon bank account is maintained including all coupons banked and redeemed. The consumer does not retain a physical coupon instead at the end of the transaction goods purchased are matched with the coupon bank selected by the consumer. Users are identified through the retailer's loyalty program or a universal coupon card for companies without a loyalty card. After products are matched the coupon value is deducted from the total bill.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to electronic coupons. More specifically, the present invention relates to electronic coupons and web based point of sale technology.

### BACKGROUND OF THE INVENTION

Coupons are commonly used to encourage potential customers to purchase products. Typically paper coupons are created and distributed through direct mailings, newspapers and magazines in widespread campaigns attempting to reach those consumers potentially interested in purchasing a product. Electronic coupons issued over the Internet or mobile device networks, which are an increasingly common tool in targeted advertising.

Today consumers are spending more time on the Internet searching for the best price, discounts or coupons. Many consumers are making purchases or orders online and using electronic coupons. Currently, for a consumer to use an electronic or online coupon, especially that of a small retailer, the consumer must print or physically bring confirmation of the coupon to redeem at the retailer's physical location.

The use of electronic coupons for retailers is limited by the infrastructure typically required to facilitate redemption and tracking. It is relatively easy to issue electronic coupons to consumers given that most consumers have some way of connecting to the Internet or a mobile device network, however often times these so called electronic coupons must still be printed and such coupons are still redeemed using the same paper based redemption, clearinghouse, and claims processes. The present invention eliminates the manual, error prone, labor intensive clearing process, significantly reduces coupon processing fees, increases validation and processing controls, reducing risks, liability, and fraudulent claims, and provides manufacturers, retailers, and consumers with an electronic alternative to coupon issuance and redemption. The benefits of less manual intervention and faster processing of coupons at checkout will result in an improved experience for both the retailer and consumer.

### SUMMARY OF THE INVENTION

The present invention is a method dealing with the marketing of manufacturer products using promotional coupons and web based point of sale technology that inventories and matches coupon promotions based on the demands of the consumer. The present invention takes shopping lists and matches coupons offered. This provides a mechanism for consumers to prioritize and anticipate buying based on expiration and/or value of coupons.

Coupons are presented to the consumer via a website. As the consumer views each coupon, he/she can select or bank any and all the coupons. A coupon bank account is maintained including all coupons banked and redeemed. The consumer does not retain a physical coupon instead follows the typical process of shopping at the retailer and/or grocery store, checkout, and at the end of the transaction goods purchased are matched with the coupon bank selected by the consumer.

Users are identified through the retailer's loyalty program or directly to using a universal coupon card for companies without a loyalty card. After products are matched the coupon value is deducted from the total bill. All transactions are authenticated similar to that of a debit card transaction.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart of the method of the present invention;

FIG. 2 is a flow chart illustrating the settlement of redemptions of the method of the present invention;

FIG. 3 is a flow chart illustrating the process of coupon redemption and processing;

FIG. 4 is a flow chart illustrating how a consumer creates a coupon bank;

FIG. 5 is a flow chart illustrating the process of redeeming a coupon from a coupon bank during a purchase;

FIG. 6 is a flow chart illustrating the method of the present invent for an exemplary transaction;

FIG. 7 is a illustrative website page showing a registration area; FIG. 8 is a illustrative website page showing available coupons; and FIG. 9 is a illustrative website page showing a consumer coupon bank account.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

In the present invention currency is defined as coupons that are issued by a manufacturer or retailer. Deposits are defined as coupons selected by a customer to be banked. Redemptions are defined as coupons matching items purchases and/or services provided. Debit equals the negative adjustments to a customer accounts.

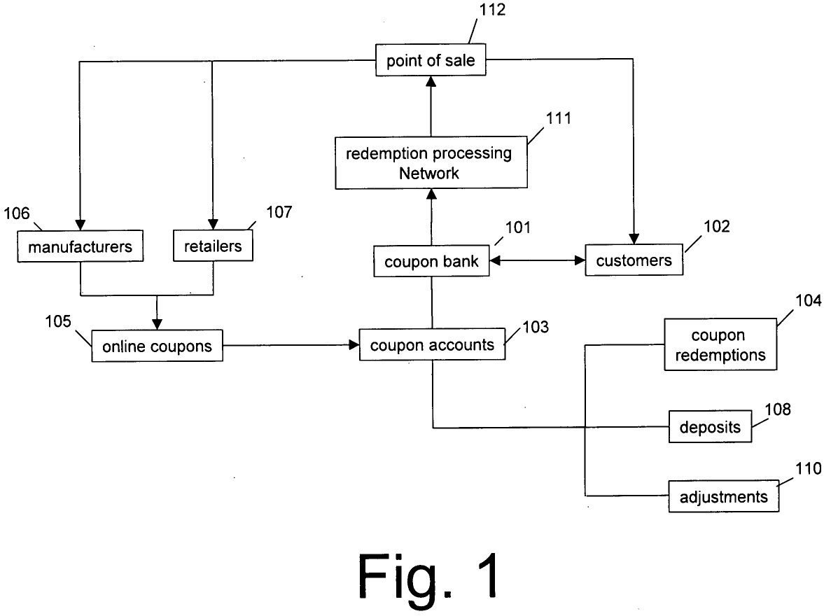

Referring to the figures, it is possible to see the various major elements constituting the method of the present invention. Now referring to FIG. 1, the present invention requires that a coupon bank 101 is an institution that acts as a payment agent for customers 102 by maintaining coupon accounts 103 for customers 102, paying out coupon redemptions 104 to customers 102, and maintaining online coupons 105 deposited to customers' accounts 103.

The primary functions of coupon bank 101 include working with manufacturers 106 and retailers 107 to issue coupons, in the form of online coupons 105. The coupon bank 101 also provides online web technology to customers 102 to track deposits 108, redemptions 109, and adjustments 110 to their coupon bank account 103. Maintenance of customer accounts 103 are subject to redemption 109 at the customer's order. The coupon bank 101 provides a redemption processing network 111, connecting retailers 107 and the coupon 101 bank for authorization of coupon redemptions at the point of sale 112.

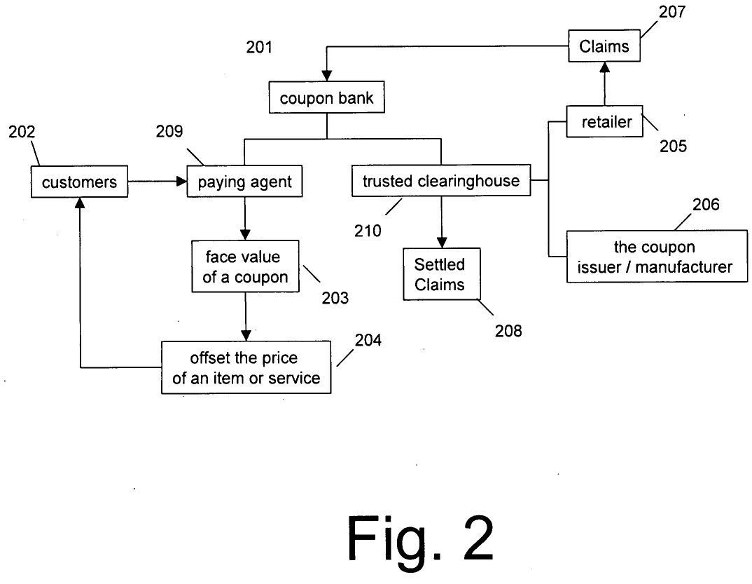

Now referring to FIG. 2, the method for the settlement of redemptions by the coupon bank serves is illustrated. The coupon bank 201 serves as a paying agent 209 for customers 202. The face value of a coupon 203 is used to offset the price of an item or service 204. The coupon bank 201 also serves as a trusted clearinghouse 210 between the retailer 205 and the coupon issuer/manufacturer 206. Claims 207 are electronically completed by the retailer 205 and are settled 208 by the coupon bank 201.

As with typical banks, a coupon bank customer will be issued a traditional magnetic strip or bar code scan card. The card stores or accesses information uniquely identifying the cardholder account number, cardholder name, and expiration date. Customers may also be identified through the retailer's loyalty program, through linking the Coupon Bank account to the retailer's loyalty program.

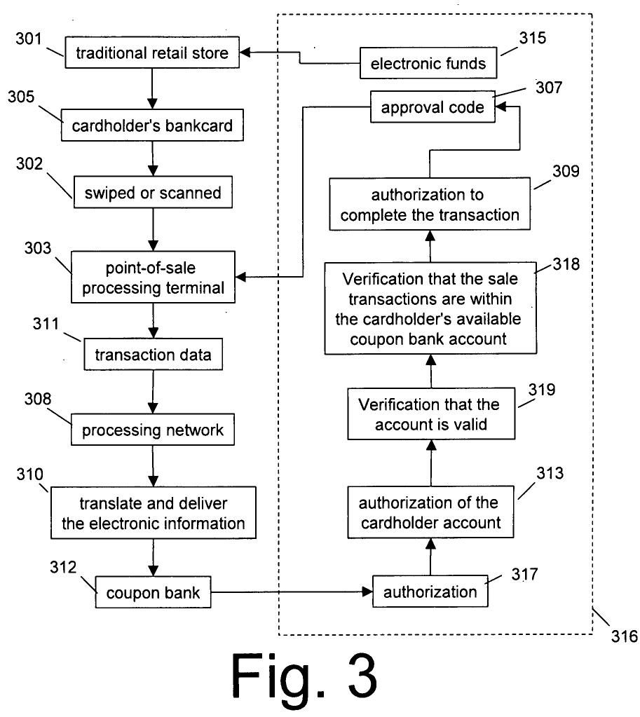

Now referring to FIG. 3, in a traditional retail store, restaurant, etc 301. the cardholder's bankcard 305 is swiped or scanned 302 through the point-of-sale processing terminal 303 and the transaction details are entered. The terminal 303 electronically reads the cardholder's account information 304 from the magnetic strip 306 on the card 305. Through the network 307 connected to the terminal 303, the terminal 303 automatically connects to the processing network 308 for authorization to complete the transaction 309.

The processing network 308 is responsible for translating and delivering the electronic information 310 sent from the point-of-sale terminal 303. The transaction data 311 is first routed to the coupon bank 312 for authorization of the cardholder account 313, with the appropriate data then sent back to the terminal 303. The processing network 308 serves as a two-way communication channel for the electronic funds 315 and data transfer process 316.

The processing network 308 sends the transaction data 311 to the coupon bank 312 for authorization 317. The coupon bank 312 verifies that the account is valid 319 and the sale transactions are within the cardholder's available coupon bank account 318. This triggers the processing network 308 to send an approval code 307 back and any data required by the retailer to the terminal 303 so the transaction can be completed. Transaction details appear on the retail receipts and the cardholder's online account statement.

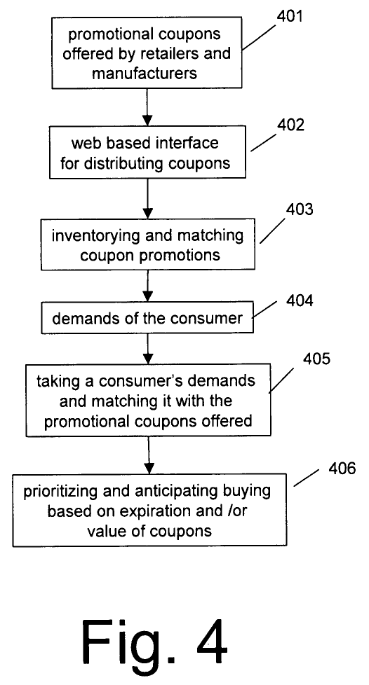

Now referring to FIG. 4, the marketing of manufacturer products is done by offering promotional coupons 401 through a web based interface 402. The present invention inventories and matches 403 coupon promotions 401 based on the demands of the consumer 404. The website software takes a consumer's shopping list 405 and matches 403 promotional coupons offered 401. This provides a mechanism for consumers 406 to prioritize and anticipate buying based on expiration and/or value of coupons.

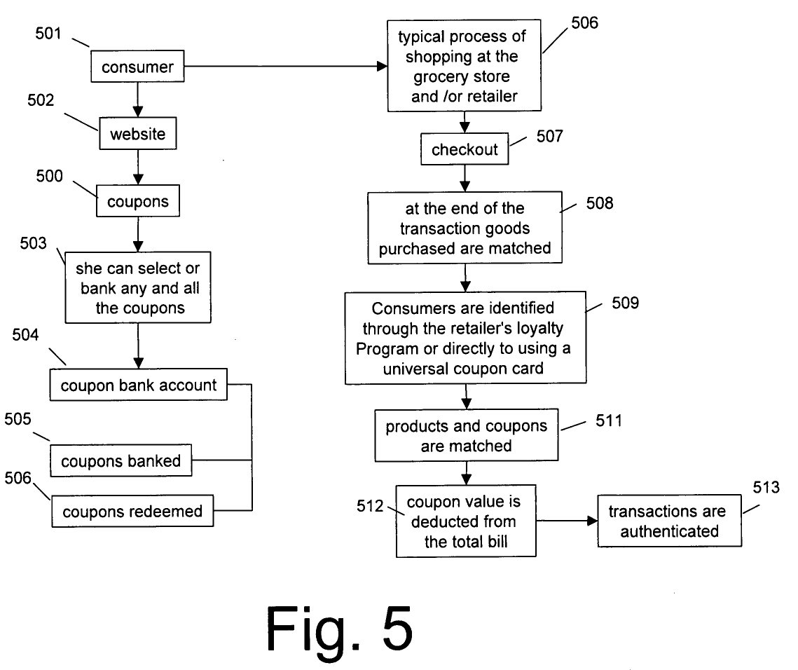

Now referring to FIG. 5, coupons 500 are presented to the consumer 501 via a website 502. As the consumer 501 views each coupon 500, he/she can select or bank 503 any and all the coupons 500. A coupon bank account 504 is maintained including all coupons 503 banked 505 and redeemed 506. The consumer 501 does not retain a physical coupon but follows the typical process of shopping at the grocery store and/or retailer 506, checkout 507, but at the end of the transaction goods purchased are matched 508 with the coupon bank account 504 selected by the consumer 503. Consumers 501 are identified through the retailer's loyalty program or directly to using a universal coupon card 509 for companies without a loyalty card program. After products are matched 511 the coupon value is deducted from the total bill 512. All transactions are authenticated 513 similar to that of a debit card transaction.

Product manufactures and retailers submit coupon data to the company including product UPC which the coupon is good for, offer descriptions, images, value and other promotional data. An unique coupon number is assigned by the company. Manufacturers can issue coupons on a schedule or as needed.

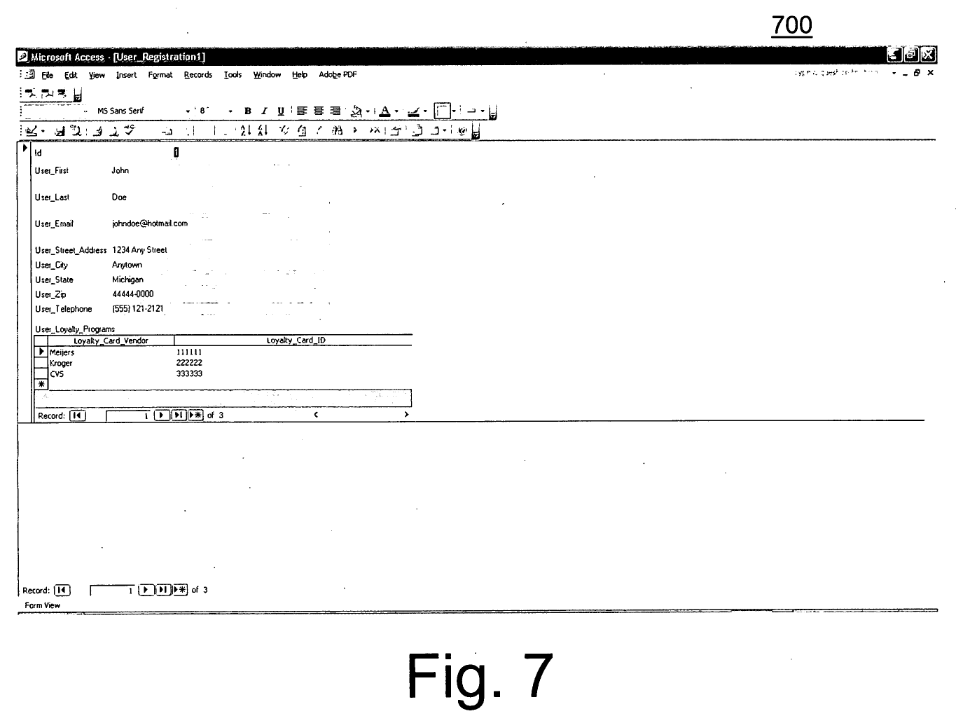

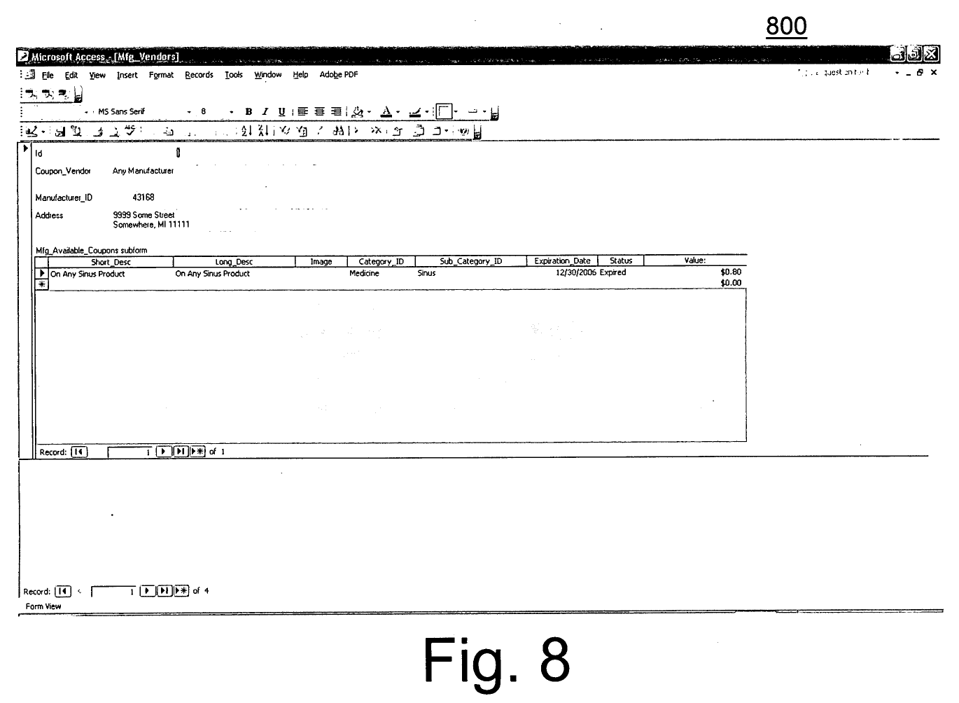

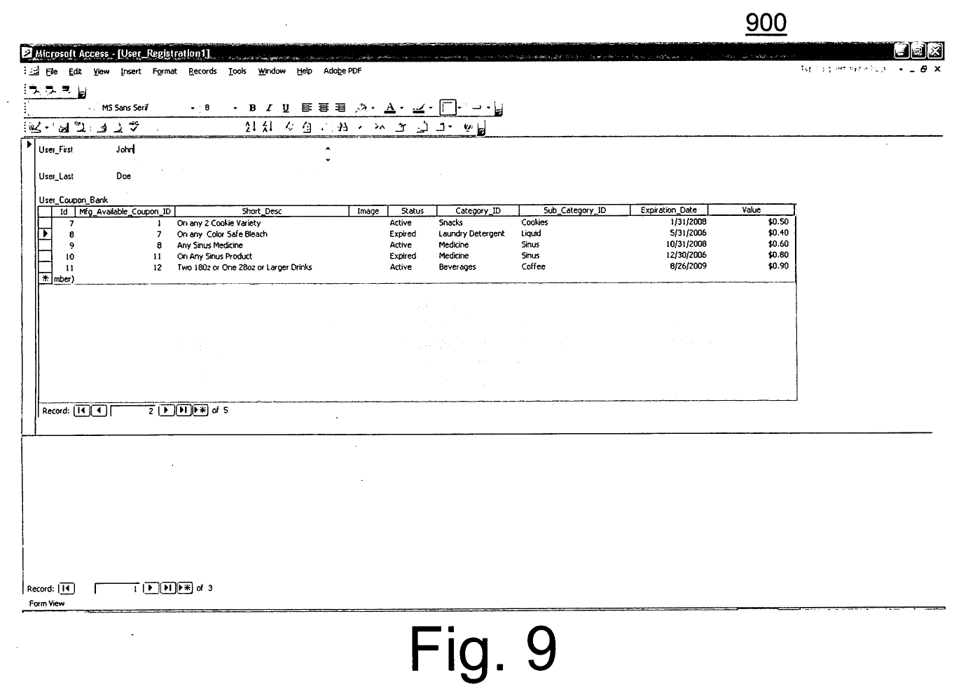

A consumer accesses a website 700 as shown in FIG. 7 to register as an user with basic information such as name, address, telephone, and existing loyalty program they wish to link to their web account. The consumer can create shopping lists/cart based on product categories, automatic and manual selection from a database of manufacturer/retail coupons grouped by product categories so that they can be linked to shopping lists/cart. Coupon offers can be also be presented by linking products with user defined recipes or published recipes. Selected or ‘clipped coupons’ are banked and retained in the user account as ‘deposits’ in their account. Coupons are automatically canceled based on the expiration date; they are represented as ‘debits’ to a user's account.

As coupons are redeemed at checkout, they are represented as ‘redeemed’ or deductions from a user's account. Online bank account statements are available for review, printing, and reconciliation as needed. No paper bank account statements will be mailed. Shopping lists are available to be printed with images of coupons, if needed and no paper coupons are printed.

Each registered user retains a bank account containing all banked coupons, redeemed coupons, and adjustments. Banked coupon data includes all data contained in the standard coupon, including value of a coupon, expiration date of a coupon, a description of a discounted product, and a description of a manufacturer of the discounted product.

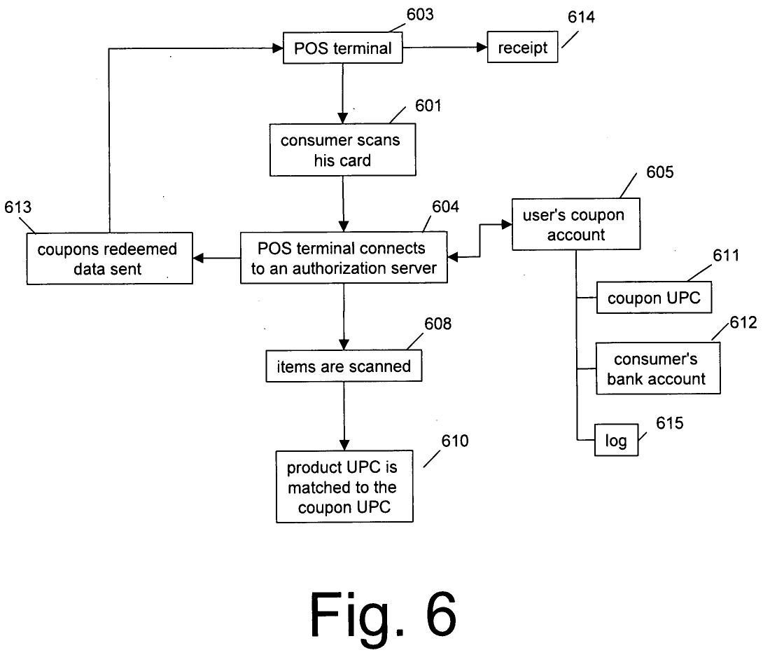

Now referring to FIG. 6, a sample transaction process is illustrated. At the point of sale (POS), the consumer scans his/her loyalty/universal card 601 and the POS terminal 603 connects to an authorization server 604 linking the transaction to the user's coupon account 605, consequently authenticating the user. The authorization server 604 can be located within the retailer's data center or centrally hosted. A dedicated asynchronous connection between the POS terminal 603 and the authorization server 604 is established. As items are scanned 608, the product UPC is matched 610 to the coupon UPC 611 stored in a consumer's bank account 612 using existing matching software, based on the manufacturer's family code or other unique identifiers. At the end of the transaction, the authorization server 604 completes the transaction and sends coupons redeemed data 613 back to the POS terminal 603 to be printed on the receipt 614. A log 615 is retained for each transaction with consumer, transaction details, and completeness checks. The log 615 is used to submit to the manufacturers for redemption of the coupon face value and processing fees.

Furthermore, other areas of art may benefit from this method and adjustments to the design are anticipated. Thus, the scope of the invention should be determined by the appended claims and their legal equivalents, rather than by the examples given.

1. A computer implemented method for redeeming coupons comprising the steps of:
providing a coupon bank;
collecting online coupons issued by manufacturers and retailers by the coupon bank;
providing computer implemented online interfaces and databases for a user to track deposits, redemptions, and adjustments to a coupon bank account;
said coupon bank acting as an institution that acts as a payment agent for users by maintaining coupon accounts users;
providing a redemption processing network;
connecting a retailer and the coupon bank for authorization of coupon redemptions at the point of sale;
paying out coupon redemptions to users; and
maintaining online coupons deposited to users' accounts.

2. The method of claim 1, further comprising the step of subjecting user accounts to redemption at the user's order

3. The method of claim 1, further comprising the step of using the coupon bank a paying agent for the users.

4. The method of claim 1, further comprising the steps of:
using the face value of a coupon to offset the price of an item or service;
using the coupon bank as a trusted clearinghouse between the retailer and the coupon issuer;
electronically completing claims by the retailer; and
settling transaction by the coupon bank.

5. The method of claim 1, further comprising the step of:
issuing a traditional magnetic strip or bar code scan card
said card stores or accesses information uniquely identifying the cardholder account number, cardholder name, and expiration date.

6. The method of claim 1, further comprising the step of:
identifying users through a retailer's loyalty program; and
linking the coupon bank account to the retailer's loyalty program.

7. The method of claim 5, further comprising the steps of:
swiping or scanning a cardholder's bankcard through a point-of-sale processing terminal;
entering the transaction details into the point-of-sale processing terminal;
said terminal electronically reading the cardholder's account information from a magnetic strip on the bankcard;
providing a network connected to the terminal;
automatically connecting the terminal to the network for authorization to complete the transaction;
routing the transaction date to a coupon bank for authorization of the cardholder account;
verifying that the account is valid and the sale transactions are within the cardholder's available coupon bank account; and
sending the appropriate data back to the terminal.

8. The method of claim 7, further comprising the steps of:
sending an approval code back and any data required by the retailer to the business' terminal so the transaction can be completed; and
including transaction details on the retail receipts and a user's online account statement.

9. The method of claim 1, further comprising the steps of:
offering promotional coupons through a web based interface;
inventorying and matching coupon promotions based on the demands of the user;
using a user's shopping list and matching promotional coupons offered to the list; and
providing a mechanism for users to prioritize and anticipate buying based on expiration and/or value of coupons.

10. The method of claim 1, further comprising the steps of:
presenting coupons to the user via a website;
as the user views each coupon, selecting or banking any and all the coupons;
maintaining a coupon bank account including all coupons banked and redeemed.

11. The method of claim 7, further comprising the steps of:
matching, at the end of a transaction, the goods purchased with the coupon bank account selected by the user;
identifying users through the retailer's loyalty program or directly to using a universal coupon card;
deducting the value of the coupons after products are matched from the total bill; and
authenticating the transaction.

12. The method of claim 1, further comprising the steps of:
submitting coupon data to the coupon bank by product manufactures and retailers, including product UPC which the coupon is good for, offer descriptions, images, value and other promotional data;
assigning an unique coupon number by the company; and
issuing coupons on a schedule or as needed.

13. The method of claim 1, further comprising the steps of:
accesses a website to register as an user with basic information such as name, address, telephone, and existing loyalty program they wish to link to their web account;
creating shopping lists and shopping carts based on product categories; and
providing automatic and manual selection from a database of manufacturer and retail coupons grouped by product categories so that they can be linked to shopping lists and cart;
banking selected coupons by retaining them in a user account as deposits in the account; and
automatically canceling coupons based on the expiration date.

14. The method of claim 1, further comprising the steps of presenting coupon offers by linking products with user defined recipes or published recipes.

15. The method of claim 13, further comprising the steps of:
as coupons are redeemed at checkout, representing them as redeemed or deductions from a user's account;
retaining a bank account for each user containing all banked coupons, redeemed coupons, and adjustments
providing online bank account statements available for review, printing, and reconciliation
providing shopping lists available to be printed with images of coupons.

16. The method of claim 15, wherein, banked coupon data includes all data contained in the standard coupon, including value of a coupon, expiration date of a coupon, a description of a discounted product, and a description of a manufacturer of the discounted product.
